(19) United States
(12) Patent Application Publication
(10) Pub. No.: US 2009/0091142 A1
(43) Pub. Date: Apr. 9, 2009

(54) Temporary hardware for a multipoint lock door

(76) Inventor: Michael L. Wilson, Fort Myers, FL (US)

Correspondence Address: Michael L. Wilson, 9298 Mooring Circle, Fort Myers, FL, 33967, US

(21) Appl. No.: 11/906,792

(22) Filed: Oct. 4, 2007

(51) Int. Cl. E05B 3/00; E05C 1/08

(52) U.S. Cl. 292/137; 292/336.3

(57) ABSTRACT

Doors, especially exterior doors are installed in a building long before the construction is finished. Many doors utilize multipoint lock assemblies or mortise locks, these doors typically have expensive hardware that needs to be installed in order to open, use or lock these doors. Continued use and handling of this hardware results in damage to the same. For this reason, the inventive concept includes low cost handles that can easily be installed and can be used over and over again. The low cost hardware consists of low cost handle that are passed through existing lock mechanisms within the door. The low cost handles include a grommet on one side of the door that will be inserted into an existing opening in the door as sealant against dirt and debris. Also included on the handle is a compressible tube on another side of the handle that acts to reduce any play within the temporary mechanism. The handles are so constructed that the doors can be operated from both sides of the doors, one side only, or none at all.

### BACKGROUND OF THE INVENTION

The inventive temporary hardware is mainly designed to be used in French doors where there is typically one passive door which is primarily locked in place and one active door which may be opened or closed. It is desirable to install a temporary hardware to operate the locking mechanism while a building is under construction. This is so because, while the building is under construction, workman such as electricians, plumbers or drywall people are moving in and out of the building site. When the door is first installed, the mortise lock is already installed by the manufacturer. If the operating mechanism, such as an escutcheon plate and the operating handles have been installed at the factory, or if they are applied prior to the completion of other trades working in the building, such may get damaged during construction. The use of the final hardware during construction will create unsightly wear and could damage the same. The final hardware is very expensive and should only be installed when the construction of the building is finished The invention allows painters to paint or otherwise treat the doors without having to remove any part of the door engaging hardware. Such construction may go on for about six months.

### BRIEF DESCRIPTION OF THE INVENTION

In view of all of the above, it is advisable to install a temporary locking system that can operate the multipoint lock assembly at anytime, it can securely lock the door at the end of a work shift or on weekends and can be opened at anytime. The system can also be locked from the inside but not from the outside.

The invention pertains to front or exterior doors which are normally very expensive. The temporary handle is preferably an inexpensive one piece bar of a square, triangular, star cross section or any other shape to match the internal latch operator that acts a mechanical spindle including a separate handle that is easily attached to the spindle. The handle and/or spindle has a stopping device such as a tension pin and washer, ez clip, fixed washer or machining to limit a travel through the locking mechanism. Preferably, this handle will have an exterior cladding designed for a comfortable feel when operating the handle. Preferably, on the opposing end of the spindle, there is a hole, tap or other machining to act as a means to easily fasten the other lever on the other side of the door. This will allow the use of a hitch pin, cotter pin, screw or any other means for securing the opposite handle on this end. The lever itself may have a means for securing itself to the spindle such as set screw or other device. Then there is a one sided spindle primarily used for the passive door involving double doors. This side does not necessarily need exterior door access in order to open the primarily active door. Various other parts or elements will be described when reference is being made to the accompanying drawings.

### BRIEF DESCRIPTION OF THE DRAWINGS

FIG. 1 represents a regular and single door,

FIG. 2 shows a French door with two slabs;

FIG. 3 shows temporary hardware that can only be operated from one side including a mortise lock arrangement;

FIG. 4 is a cross section through the lock of FIG. 3;

FIG. 5 illustrates temporary hardware that can operated from both sides of a door including a mortise lock arrangement;

FIG. 6 shows a cross section through French doors, where one door can be operated from any given side but not the other;

FIG. 7 illustrates a temporary locking assembly on a French door that cannot be operated from any side of the doors;

FIGS. 8-10 show the different elements on a temporary handle;

FIGS. 11 and 12 show the outline of a flexible grommet to be inserted into an opening in the door;

FIGS. 13 and 14 show temporary elements that will operate a dead bolt mechanism in a door.

### DETAILED DESCRIPTION OF THE INVENTION

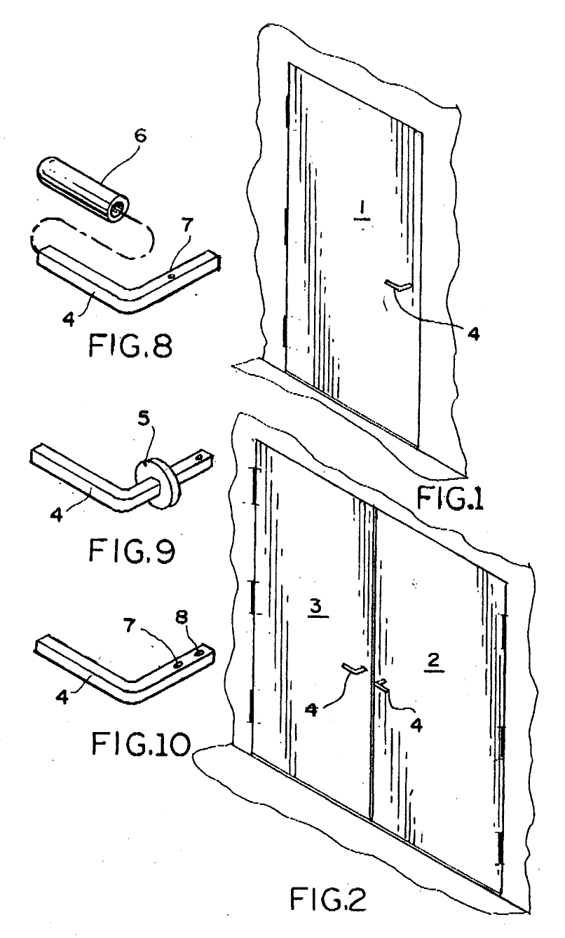

FIG. 1 shows regular single door with a temporary door handle 4 installed therein.

FIG. 2 shows a French door having a normal passive door 2 with a temporary handle 4 installed therein and then there is the active door 3 which also has a temporary handle 4 installed therein.

FIGS. 8-9 illustrate one version of a preferred temporary door handle 4 including the various elements on the handle that will be explained as the description continues. Thus, on handle 4 there may be a flexible grommet that will fit into an opening of the door as a sealant. The handle 4 may have a cladding 6 on the handle which could be made out of rubber and slipped over the hand operated part of the handle. The hole 7 represents a hole used for a limiting mechanism such as a tension pin and washer (not shown). The hole 8 represents an opening that may act as a means for attaching the opposing handle as described above.

FIG. 3 shows the temporary installation of a lock operating mechanism that can only be manipulated from one side of the door 1. The side can be chosen. The temporary mechanism consists of a square bolt 9 having a head or knob 12 thereon. The bolt is inserted through the existing latch mechanism in the door. The existing latch bolt 15 is operated from within the door. The square low cost bolt 9 is passed through the existing square hole 2a. Once passed there through, the square bolt 9 receives a compressible tube 14 on its other end and then the temporary or plain handle 10 is passed over the end and compressed against the compressible tube 14 and the plain handle 10 is retained in a vertical or horizontal position on the square bolt 9 by way of the hitch pin 11 which is received in the hole 8. The reason for using a compressible tube 14 is to remove any play between the various elements once the temporary mechanism is installed, or the tubular section 14 may be rigid and be incorporated within said handle allowing the handle to slide up against the lock housing and/or an escutcheon plate, thereby eliminating any play in the handle.

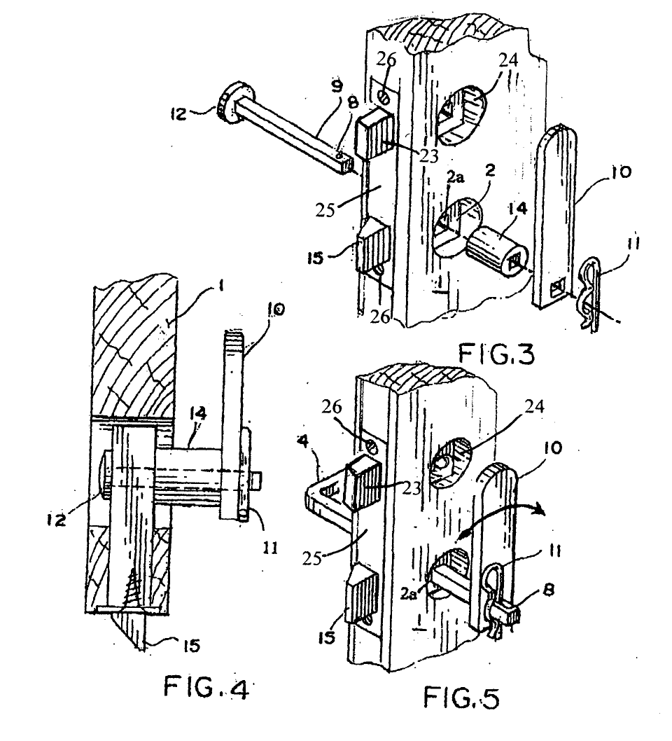

FIG. 4 shows the same mechanism of FIG. 3 except in a side view. The same reference characters have been applied.

FIG. 5 illustrates the same mechanism as was described in FIGS. 3 and 4 except that the handle 9 in FIG. 3 has been replaced by an operating handle 4. This way, the door 1 can be operated from both sides. Handle 10 can be attached to handle 4 in any position.

FIGS. 3 and 5 also show a dual function mortise lock assembly that is self-contained in a casing 25 that will be inserted by others, before the door is delivered, into a corresponding recess within the door. The dead bolt mechanism is further described in FIGS. 13 and 14. The cylinder 17 (FIGS. 13 and 14) is accessible through the opening 24 in FIGS. 3 and 5. The dead bolt 23 is operated as is described in FIGS. 13 and 14. As described above, the casing 25 located within the door recess is held in place by way of, typically, screws 26 during prior installation by others.

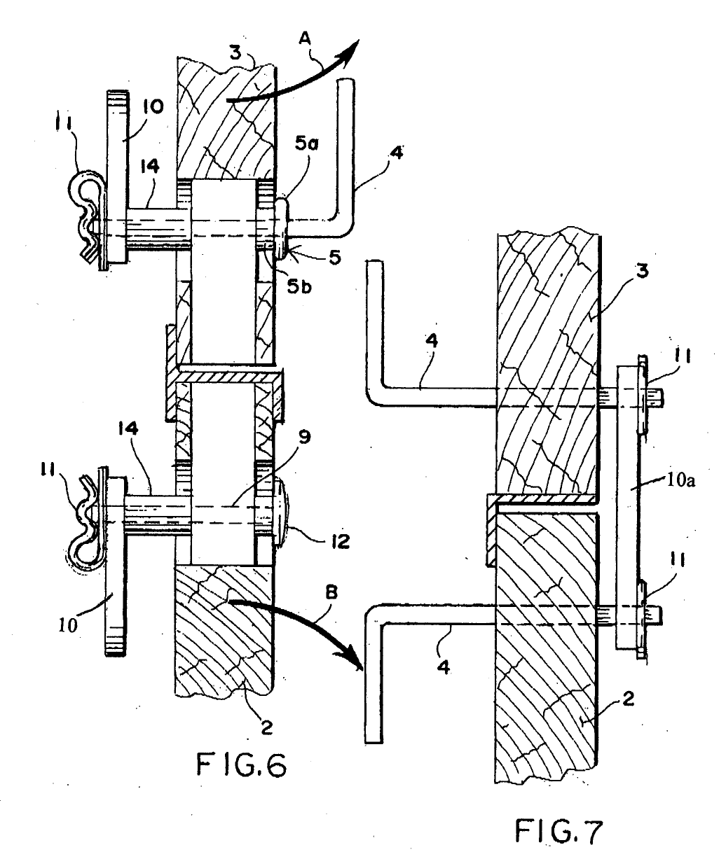

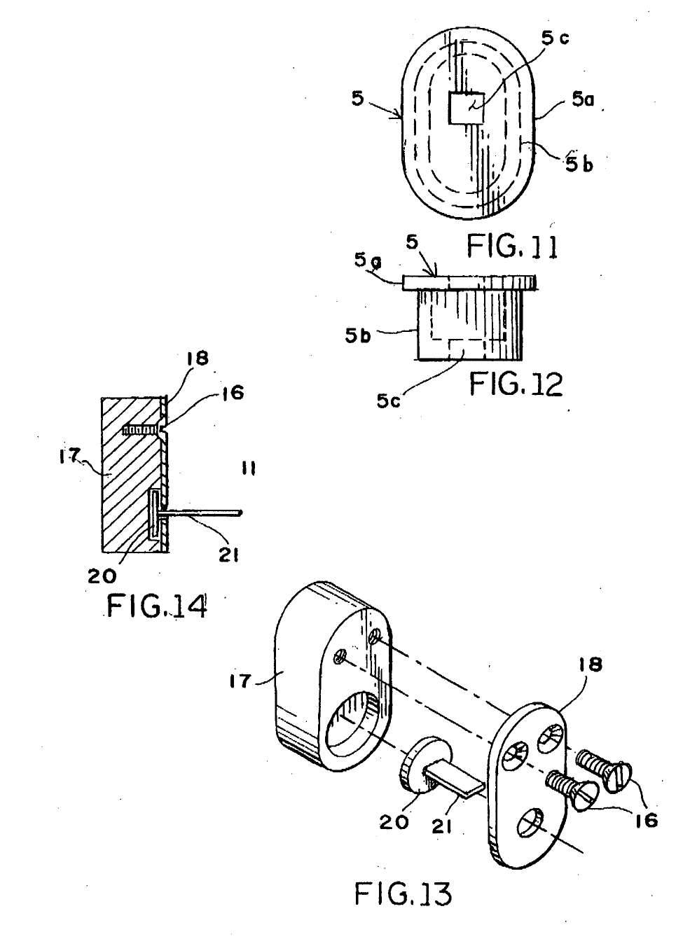

FIG. 6 shows a different embodiment of the temporary door operating mechanism. In this cross sectional view there are French doors 2 and 3. The door 3 has a temporary handle mechanism installed that can be operated from both sides of the door. This is similar to the mechanism shown in FIG. 5. The door 2 has a temporary mechanism that can only be operated from one side of the door. This view is similar to the one shown in FIGS. 3 and 4. An additional element 5 is shown in FIG. 6. This grommet is shown in more detail in FIGS. 11 and 12. As mentioned above, this grommet 5 a base 5b and a flange 5a. The base may be made in an oblong or circular shape depending on the opening in the doors where the grommet 5 is being installed. As also mentioned above, the grommet is preferably made of a pliable material such as soft rubber, or it may be rigid with a gasket-like backing. It is mainly used as a sealant when the temporary lock is installed so that any dirt or debris cannot enter any of the existing lock elements in the door.

FIG. 7 shows two doors 2 and 3 that cannot move relative to each other. In this embodiment, each door 2 and 3 has a handle 4 installed and each of the ends of the handles 4 receives a cross or arresting bar 10a which is held in place by hitch pins 11 at the ends of the handles 4. This way the doors 2 and 3 cannot be operated from any side of the doors and they remain locked to relative to each other to prevent any passage of workmen through that particular door. The bar can easily be removed and used as a handle to access the door and or signage can also be attached to the bar explaining the reason for the blockage, such as: “wet tile”. This installation is desirable where there are French doors already installed in a building but they should remain locked relative to each other to prevent any passage of workmen through that particular door.

FIGS. 8-10 have already been described with regards to FIGS. 1 and 2 above and the use of the handles 4 can easily be gleaned from later Figs.

FIGS. 11 and 12 illustrate the outlines of the grommet 5 which has been explained above already with regard to FIG. 6. The grommet 5 has a flange 5a and a base 5b. As explained above, the grommet 5 acts as a sealant when installed in a temporary lock. The grommet may be used or might not be used, depending on the application and/or user preference. It is recommended that it is used in highly corrosive environments such as ocean front buildings. Also in these Figs., there can be seen the square hole 5c through which any of handles described above will pass when installing the grommet 5.

FIGS. 13 and 14 illustrate one of different types of deadbolt actuator assemblies that may be used in conjunction with the temporary handles. The type of deadbolt actuator assembly will vary depending on the type of multipoint mortise lock assembly used within a door. The cylinder 20 is held in place by way of a plate 18 covering the block and further by way of the screws 16. The housing 17 eliminates access to the dead bolt mechanism from the exterior (FIG. 3). The protruding stem 21 can be used to operate the dead bolt 24. The stem 21 that is normally operated by way of a thumb turn.

### CONCLUSION

A temporary locking system and/or temporary hardware has been developed that will preserve the integrity and quality of the final hardware while allowing users to activate the multipoint or mortise lock assemblies that come with the doors when they are delivered to the building site. The temporary door hardware elements are low cost items. The finished hardware is quite expensive and should not be installed prior to the completion of most trades working in the building.

What I claim is:

1. A temporary locking mechanism on a door having only a multi-point assembly installed in an opening therein but no handle or other elements comprising: a low cost handle having a square cross section, said handle is passed into an existing latch mechanism from a first side of said door, a grommet is passed over said handle on that side of the door, a compressible tube is passed over said handle on a second side of said door, a plain handle is next passed over said low cost handle including means for retaining said plain handle at an end of said low cost handle.

2. The temporary locking mechanism of claim 1, wherein said grommet is a pliable sealant in said opening of said door.

3. The temporary locking mechanism of claim 1, wherein said means for retaining said plain handle at an end of said low cost handle is a hitch pin passing through a hole in said handle.

4. The temporary locking mechanism of claim 1, wherein said low cost handle on said first side of said door has an L-shaped extension as an aid in manipulating said low cost handle.

5. The temporary locking mechanism of claim 1, wherein said low cost handle on said first side of said door has knob attached thereto which is in contact with said grommet, whereby said locking mechanism can only be operated from one said side of said door.

6. A temporary locking mechanism on French doors having two doors, wherein each of said doors has only installed a latching mechanism in an opening therein but no other elements, wherein each of said temporary locking mechanisms has a low cost handle having a square cross section being passed through said latching mechanisms on a first side of each of said doors and a single arresting bar is installed over each end of said low cost handles on a second side of said doors whereby both doors are prevented from operating relative to each other because the low cost handles cannot be turned.

7. A temporary locking mechanism on French doors having two doors, wherein both of said doors have only installed a latching mechanism in an opening therein but no other elements, wherein a first of said doors has a low cost handle installed therein with a square cross section, said low cost handle is passed into an existing latch mechanism from a first side of said door, a grommet is passed over said handle on said side of said first door, a compressible tube is passed over said handle on said second side of said first door, and, wherein a plain handle is next passed over said low cost handle at an end thereof, means for retaining said plain handle at said end thereof, and, wherein said second door of said French doors has a low cost handle passed through said existing latch mechanism at a first side of said second door, said low cost handle having a plain handle attached at its outer end, said second door having a low cost handle passed through its existing latch mechanism said low cost handle having at its end on a second side a knob attached thereto, said knob is flush with said first side of said second door, whereby both doors of said French doors can be operated on said second sides of said doors, and, whereby only said first door on said first side of said French doors can be operated but not said second door.

8. The temporary locking mechanism of claim 7, wherein said means for retaining said plain handles on both ends of said handles is a hitch pin.

9. A temporary lock actuator assembly for an existing multipoint assembly in a door but no other operating elements, said temporary locking mechanism including a lock actuator plate placed within said existing housing and having an operating stem thereon pointing to an inside of said door, a cover plate retaining said plate within said housing, means for fastening said cover plate on said housing, whereby said stem and lock can be operated by a tool.

10. A temporary locking mechanism on a door including a dead bolt mechanism and a handle operated latch mechanism, said dead bolt mechanism and said handle operated latch mechanism are contained in a casing, said casing is installed in a recess in said door, said dead bolt mechanism includes a temporary cylinder having a dead bolt activation assembly contained therein, said dead bolt activation assembly includes a plate having a stem a forward stem located thereon which is accessible by way of a tool through and opening in said door, said handle operated latch mechanism includes a handle having a square cross section which is passed through an opening in said latch mechanism from one side of said door and said handle having a low cost handle attached to an end of said handle at another side of said door, both of said mechanisms can be operated independently from each other.
